(19) United States
(12) Patent Application Publication
(10) Pub. No.: US 2007/0011947 A1
(43) Pub. Date: Jan. 18, 2007

(54) Arrangement in a swing door apparatus for the detection of door position

(76) Inventor: Arto Koponen, Kasama (FI)

Correspondence Address: SMITH-HILL AND BEDELL, P.C., 16100 NW CORNELL ROAD, SUITE 220, BEAVERTON, OR, 97006, US

(21) Appl. No.: 10/551,529

(22) PCT Filed: Mar. 25, 2004
(86) PCT No.: PCT/FI04/00167

§ 371 Date: Sep. 30, 2005

(30) Foreign Application Priority Data
Apr. 2, 2003 (FI) 20030495

(51) Int. Cl. E05F 11/24

(52) U.S. Cl. 49/341

(57) ABSTRACT

An arrangement in a swing door apparatus for the detection of door position, which swing door apparatus comprises an operation shaft, the turning of which follows the door movements. The detection of door position is arranged to be provided by potentiometric means or the like, which have at least substantially identical characteristic curves and which are arranged operatively dependent on the turning angle of said operation shaft.

The invention relates to an arrangement in a swing door apparatus for the detection of door position in accordance with the preamble of claim 1, which swing door apparatus comprises an operation shaft, the turning of which follows the door movements.

The swing door apparatus refers here to such an arrangement, where at least the opening of the door is driven by an electric motor. The closing of the door may also be actuated by means of an electric motor, but optionally a door closer connected to the apparatus may activate the closing as well.

Conventionally in the swing door automatics, the door position and speed have been studied by employing microswitches, or a permanent magnet combination or a Hall sensor array either together with or without a pulse disc, or an optically readable pulse disc.

These methods have a common problem, i.e. they have not allowed continuous measuring at the very moment power is switched on to the swing door apparatus. It has been necessary for the swing door apparatus to take the door to a given predetermined position, for instance against a doorframe, from where it has been possible to initiate the relative counting.

An object of the invention is to provide a novel arrangement to be applied to a swing door apparatus for the detection of door position, wherein the problems related to prior art arrangements are eliminated. The arrangement should also be simple and low-cost.

The objects of the present invention may be achieved in a way described in claim 1 and in the other claims. The detection of door position is arranged to be provided by potentiometric means or the like, which are arranged operatively dependent on the turning angle of the operation shaft of the swing door apparatus. According to the invention said potentiometric means comprise preferably two potentiometers which have at least substantially identical characteristic curves and which are arranged in conjunction with a common shaft so that they most preferably are in a phase shift of 180° with respect to one another. The solution is inexpensive and simple. Once power is switched on to the apparatus, a single action of reading the voltage of the slider member of the potentiometer, independently of the present phase of the opening or closing sequence of the door, is sufficient for the detection of door position.

By using two potentiometers, which are provided with revolving slider members, the problem related to the point of discontinuity of one potentiometer, can be avoided. Thereby, when installing a swing door arrangement, it does not make any difference at which position with regard to the characteristic curve of a potentiometer the closed position of the door is located, since the discontinuity points of the characteristic curves of the potentiometers are in phase shift with regard to each other and, thus, there is always at least one potentiometer available whichever is the phase of opening of the door in each case.

Then, the arrangement further comprises with advantage a control unit, for instance a programmable logic circuit or a microprocessor, which is arranged to select each time the potentiometer to be used for the detection of door position so that the position detecting will be performed within the linear range of the potentiometer in use.

The potentiometric means may preferably be arranged in conjunction with a rotatable member, which is dependent on the turning of said operation shaft. In this manner a separate compact-detector unit may be provided so as to be connected to the swing door apparatus. The rotational freedom of said rotatable member corresponds preferably to the swinging of the door from its closed position to the maximum opened position. In practice, said rotatable member may preferably be a gear wheel or the like, which is mechanically coupled to said operation shaft and arranged to rotate said shaft of the potentiometric means.

When an electric motor to be connected to said operation shaft in a manner known per se, and a power source are included in the swing door apparatus, said potentiometric means may receive their power supply conveniently transformed from said power source.

In the following the invention is described by way of example with reference to the attached drawings, in which

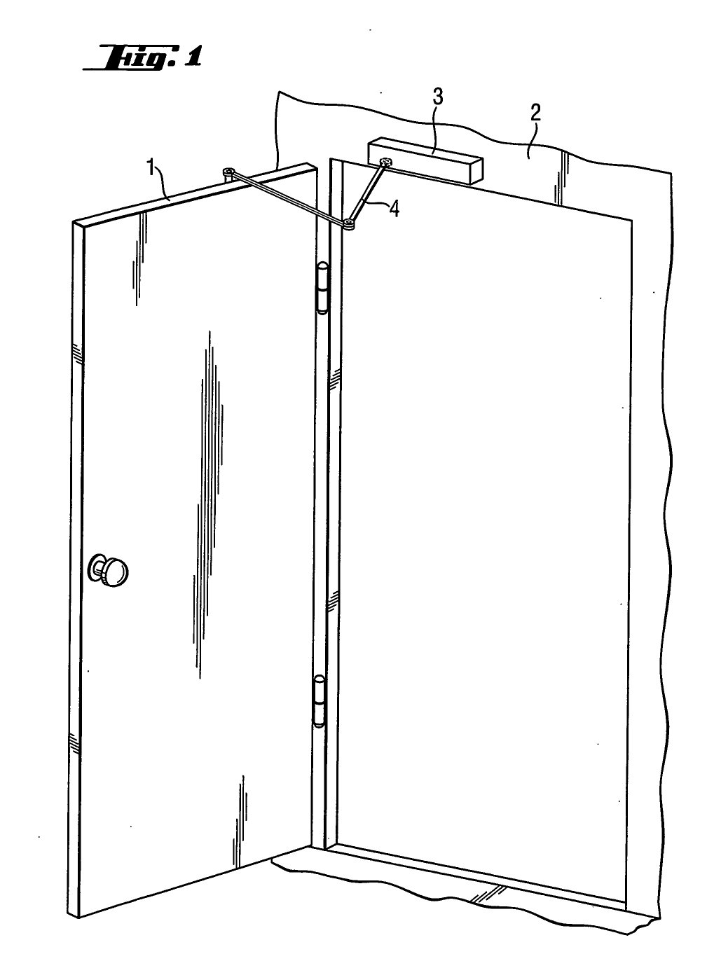

FIG. 1 shows a general arrangement of a swing door apparatus;

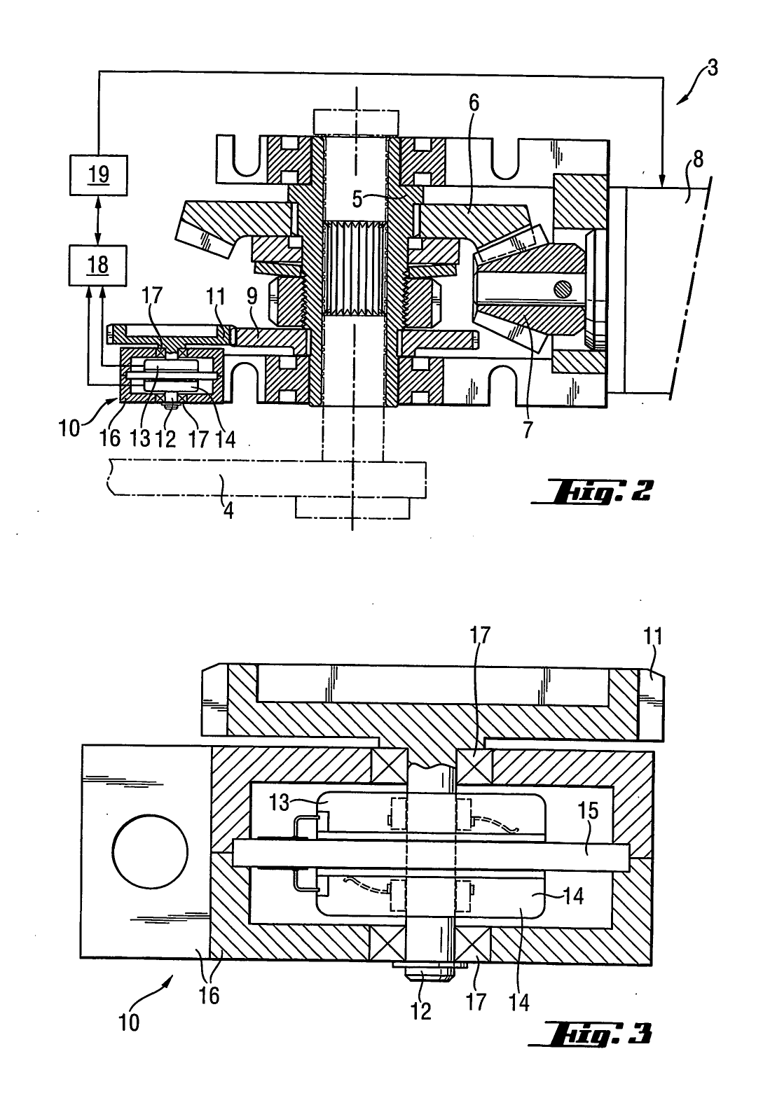

FIG. 2 shows a part of a swing door apparatus as side projection and provided with a position detecting arrangement according to the invention;

FIG. 3 shows an enlarged position detecting arrangement according to FIG. 2;

FIG. 4 shows the connection diagram of the position detecting arrangement according to the invention;

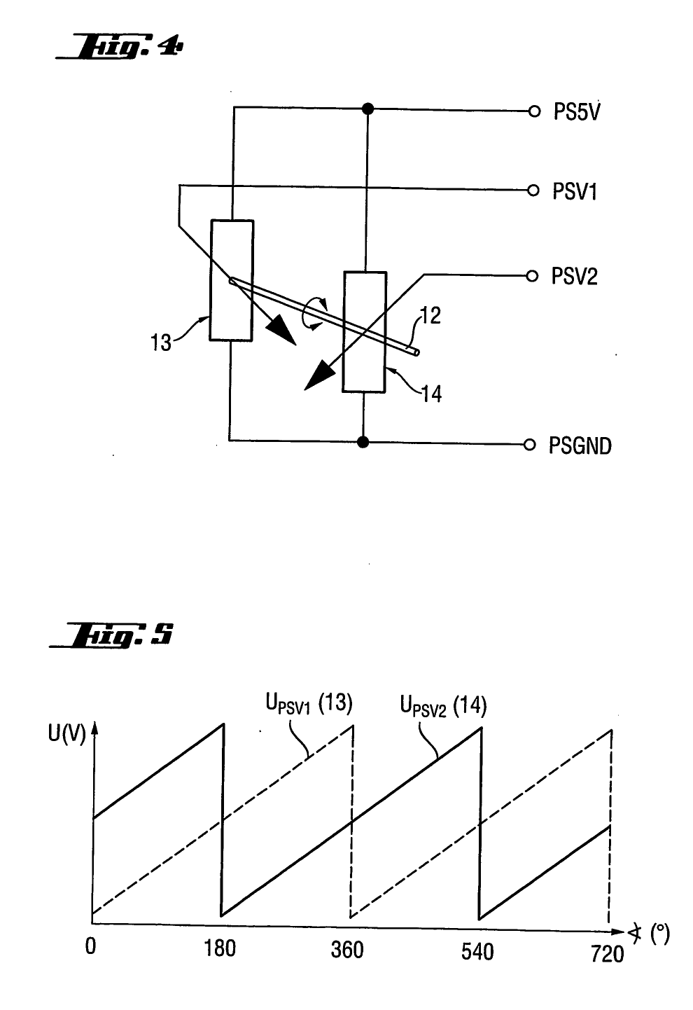

FIG. 5 illustrates the principle of measuring applied to the position detecting arrangement according to the invention.

In accordance with FIG. 1 a door 1 is hinged on a doorframe 2 and provided with a swing door apparatus 3, which is connected to the door by means of turning swing arms 4.

FIG. 2 illustrates a part of a swing door apparatus comprising an operation shaft 5, which is connected to the door by means of turning swing arms 4 so that it turns concurrently with the swinging of the door (not shown in detail). The operation shaft 5 is by means of gear wheels 6 and 7 connected to an electric motor 8, by which the door may be opened and closed. The operation shaft 5 is provided with another gear wheel 9 as well, which is operatively connected to a gear wheel 11 included in a door position detecting arrangement 10 and to a shaft 12 connected thereto. The swing door apparatus also comprises a power source 18 and a control unit 19, which are shown only schematically in the figures. These are responsible for the power supply and the control of the entire apparatus, respectively, including the position detecting arrangement 10. The control unit 19 may preferably be e.g. a microprocessor.

In conjunction with the shaft 12, as shown in more detail in FIG. 3, there are potentiometers 13 and 14 coupled with a circuit plate 15, by which devices the position detecting according to the invention is accomplished. The position detecting arrangement 10 also includes a body piece 16, by means of which it may be attached to the swing door apparatus itself, and bearings 17 for the shaft 12. The circuit plate 15 is installed within the body piece 16 of the position detecting arrangement 10.

FIGS. 4 and 5 show the coupling and the principle of measurement of the potentiometers 13 and 14 in the position detecting arrangement 10. Thus, according to the invention, preferably two potentiometers 13 and 14 are employed, which are provided with revolving slider members and preferably arranged with respect to the shaft 12 so that they find themselves in a phase shift of 180° with respect to one another. By this, the point of discontinuity of the potentiometer 14 will be situated in the middle of the linear measuring range of the potentiometer 13 and correspondingly, the discontinuity point of the potentiometer 13 will be located in the middle of the linear measuring range of the potentiometer 14. In practice, the control unit 19 is arranged to select each time the potentiometer to be used for the detection of door position so that the linear measuring range of one or the other potentiometer is in use.

The invention is not limited to the above-described application, but several modifications are conceivable in the scope of the appended claims.

1-6. (canceled)

7. An arrangement in a swing door apparatus for the detection of door position, which swing door apparatus comprises an operation shaft, the turning of which follows the door movements, whereby the detection of door position is arranged to be provided by potentiometric means or the like, which are arranged operatively dependent on the turning angle of said operation shaft, wherein said potentiometric means comprise two potentiometers, which have at least substantially identical characteristic curves and which are arranged in conjunction with a common shaft so that they preferably find themselves in a phase shift of 180° with respect to one another.

8. A position detecting arrangement according to claim 7, wherein it comprises a control unit, for instance a programmable logic circuit or a microprocessor, which is arranged to select each time the potentiometer to be used for the detection of door position so that the position detecting is performed within the linear range of the potentiometer in use.

9. A position detecting arrangement according to claim 7, wherein said potentiometric means are arranged in conjunction with a rotatable member dependent on the turning of said operation shaft.

10. A position detecting arrangement according to claim 9, wherein the rotational freedom of said rotatable member corresponds to the swinging of the door from its closed position to the maximum opened position.

11. A position detecting arrangement according to claim 9, wherein said rotatable member is a gear wheel or the like, which is mechanically coupled to said operation shaft and arranged to rotate said shaft of the potentiometric means.

12. A position detecting arrangement according to claim 7, wherein the swing door apparatus comprises an electric motor to be connected to said operation shaft in a manner known per se, and a power source, and that said potentiometric means receive their power supply from said power source.
